(19) United States
(12) Patent Application Publication
(10) Pub. No.: US 2023/0407624 A1
(43) Pub. Date: Dec. 21, 2023

(54) SYSTEM AND METHOD FOR A PORTABLE DIGITAL POD

(71) Applicant: ShareSafe Solutions, LLC, Mobile, AL (US)

(72) Inventors: Robert B. Hanson, II, Mobile, AL (US); Robert Hanson, III, Mobile, AL (US); Patricia Cozad, Mobile, AL (US); Garry Gause, Birmingham, AL (US); Dean Kei Naritoku, Mobile, AL (US); Barry Sudduth, Easley, SC (US)

(73) Assignee: ShareSafe Solutions, LLC, Mobile, AL (US)

(21) Appl. No.: 18/128,198

(22) Filed: Mar. 29, 2023

Related U.S. Application Data
(60) Provisional application No. 63/324,834, filed on Mar. 29, 2022.

(51) Int. Cl. E04B 1/348; E04B 1/343; F41H 3/02; F41H 5/013

(52) U.S. Cl. CPC E04B 1/34815; E04B 1/34384; F41H 3/02; F41H 5/013; B64U 2201/00

(57) ABSTRACT

A system and method for a portable digital pod is provided. Generally, the system comprises a collapsible pod having a framework that can be expanded and collapsed using a hydraulic/pneumatic pack. The system may also comprise a computing device and display, wherein a user interface of the computing device may be manipulated by a user in a way that causes data of the system to be transmitted to said display and presented in a display user interface of said display. Security devices/methods of the system may be used to prevent unwanted access to the system and the data contained therein.

### CROSS REFERENCES

This application claims priority to U.S. Provisional Application Ser. No. 63/324,834, filed on Mar. 29, 2022, in which application is incorporated herein in its entirety by reference.

### FIELD OF THE DISCLOSURE

The subject matter of the present disclosure refers generally to a system and method for a portable digital pod.

### BACKGROUND

Portable buildings offer many advantages. Flexible design of portable building allows for a vast array of usage options. Further, they are generally cost-effective solutions in areas where more permanent structures are not desirable. However, portable buildings are not all highly portable, and the more easily portable they are, the more basic in design and functionality they tend to be. For instance, mobile homes are portable buildings, but they require roads and large vehicles in order to be transported to a desired location. Tents are also portable structures, and though they are far more portable than mobile homes, they offer very little in terms of usage options. This seemingly inversely proportional relationship between portability and versatility makes designing portable structures for a variety of usage cases, such as natural disaster relief buildings, mobile healthcare facilities, portable athletic film rooms, and military forward operating base structures, quite difficult. Further, larger portable structures often need more people and/or equipment to setup, reducing the cost effectiveness and convenience of said larger portable structures.

Accordingly, there is a need in the art for a system and method of a portable digital pod that allows users to quickly and easily setup so that essential tasks may be undertaken at critical times in as efficient a manner as possible.

### DESCRIPTION OF THE DRAWINGS

These and other features, aspects, and advantages of the present disclosure will become better understood with regard to the following description, appended claims, and accompanying drawings where:

FIG. 1 is a diagram illustrating a system embodying features consistent with the principles of the present disclosure.

FIG. 2 is a diagram illustrating a system embodying features consistent with the principles of the present disclosure.

FIG. 3 is a diagram illustrating a system embodying features consistent with the principles of the present disclosure.

FIG. 4 is a diagram illustrating a system embodying features consistent with the principles of the present disclosure.

FIG. 5A is a diagram illustrating a portable digital pod system designed to assist healthcare personnel to carry out healthcare tasks.

FIG. 5B is a diagram illustrating a portable digital pod system designed to assist healthcare personnel to carry out healthcare tasks.

FIG. 6 is a diagram illustrating a portable digital pod system designed to assist military personnel to carry out military related tasks.

FIG. 7 is a diagram illustrating portable digital pod systems designed to assist emergency personnel to carry out emergency related tasks.

FIG. 8 is a diagram illustrating a portable digital pod system designed to assist retail personnel to carry out retail related tasks.

FIG. 9 is a diagram illustrating a portable digital pod system in a collapsed position and an expanded position.

FIG. 10 is a diagram illustrating a portable digital pod system moving from a collapsed position to an expanded position.

FIG. 11 is a diagram illustrating the manner in which individual access to data may be granted or limited based on user roles or administrator roles.

FIG. 12 is a flow chart illustrating certain method steps of a method embodying features consistent with the principles of the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For instance, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, steps, etc. are optionally present. For instance, a system “comprising” components A, B, and C can contain only components A, B, and C, or can contain not only components A, B, and C, but also one or more other components. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

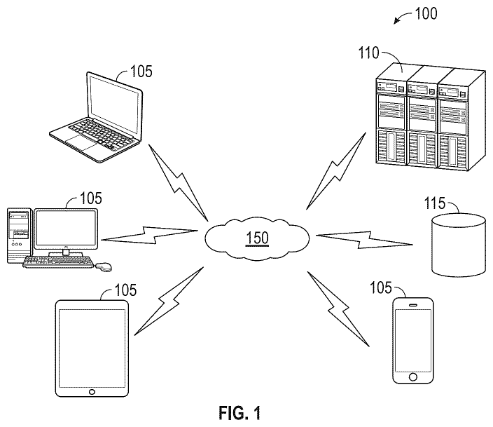

FIG. 1 depicts an exemplary environment 100 of the system 400 consisting of clients 105 connected to a server 110 and/or database 115 via a network 150. Clients 105 are devices of users 405 that may be used to access servers 110 and/or databases 115 through a network 150. A network 150 may comprise of one or more networks of any kind, including, but not limited to, a local area network (LAN), a wide area network (WAN), metropolitan area networks (MAN), a telephone network, such as the Public Switched Telephone Network (PSTN), an intranet, the Internet, a memory device, another type of network, or a combination of networks. In a preferred embodiment, computing entities 200 may act as clients 105 for a user 405. For instance, a client 105 may include a personal computer, a wireless telephone, a streaming device, a “smart” television, a personal digital assistant (PDA), a laptop, a smart phone, a tablet computer, or another type of computation or communication interface 280. Servers 110 may include devices that access, fetch, aggregate, process, search, provide, and/or maintain documents. Although FIG. 1 depicts a preferred embodiment of an environment 100 for the system 400, in other implementations, the environment 100 may contain fewer components, different components, differently arranged components, and/or additional components than those depicted in FIG. 1. Alternatively, or additionally, one or more components of the environment 100 may perform one or more other tasks described as being performed by one or more other components of the environment 100.

As depicted in FIG. 1, one embodiment of the system 400 may comprise a server 110. Although shown as a single server 110 in FIG. 1, a server 110 may, in some implementations, be implemented as multiple devices interlinked together via the network 150, wherein the devices may be distributed over a large geographic area and performing different functions or similar functions. For instance, two or more servers 110 may be implemented to work as a single server 110 performing the same tasks. Alternatively, one server 110 may perform the functions of multiple servers 110. For instance, a single server 110 may perform the tasks of a web server and an indexing server 110. Additionally, it is understood that multiple servers 110 may be used to operably connect the processor 220 to the database 115 and/or other content repositories. The processor 220 may be operably connected to the server 110 via wired or wireless connection. Types of servers 110 that may be used by the system 400 include, but are not limited to, search servers, document indexing servers, and web servers, or any combination thereof.

Search servers may include one or more computing entities 200 designed to implement a search engine, such as a documents/records search engine, general webpage search engine, etc. Search servers may, for example, include one or more web servers designed to receive search queries and/or inputs from users 405, search one or more databases 115 in response to the search queries and/or inputs, and provide documents or information, relevant to the search queries and/or inputs, to users 405. In some implementations, search servers may include a web search server that may provide webpages to users 405, wherein a provided webpage may include a reference to a web server at which the desired information and/or links are located. The references to the web server at which the desired information is located may be included in a frame and/or text box, or as a link to the desired information/document. Document indexing servers may include one or more devices designed to index documents available through networks 150. Document indexing servers may access other servers 110, such as web servers that host content, to index the content. In some implementations, document indexing servers may index documents/records stored by other servers 110 connected to the network 150. Document indexing servers may, for example, store and index content, information, and documents relating to user accounts and user-generated content. Web servers may include servers 110 that provide webpages to clients 105. For instance, the webpages may be HTML-based webpages. A web server may host one or more websites. As used herein, a website may refer to a collection of related webpages. Frequently, a website may be associated with a single domain name, although some websites may potentially encompass more than one domain name. The concepts described herein may be applied on a per-website basis. Alternatively, in some implementations, the concepts described herein may be applied on a per-webpage basis.

As used herein, a database 115 refers to a set of related data and the way it is organized. Access to this data is usually provided by a database management system (DBMS) consisting of an integrated set of computer software that allows users 405 to interact with one or more databases 115 and provides access to all of the data contained in the database 115. The DBMS provides various functions that allow entry, storage and retrieval of large quantities of information and provides ways to manage how that information is organized. Because of the close relationship between the database 115 and the DBMS, as used herein, the term database 115 refers to both a database 115 and DBMS.

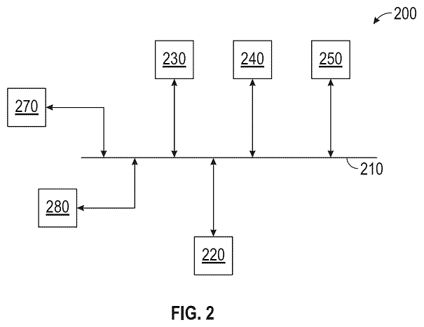

FIG. 2 is an exemplary diagram of a client 105, server 110, and/or or database 115 (hereinafter collectively referred to as “computing entity 200”), which may correspond to one or more of the clients 105, servers 110, and databases 115 according to an implementation consistent with the principles of the invention as described herein. The computing entity 200 may comprise a bus 210, a processor 220, memory 304, a storage device 250, a peripheral device 270, and a communication interface 280 (such as wired or wireless communication device). The bus 210 may be defined as one or more conductors that permit communication among the components of the computing entity 200. The processor 220 may be defined as logic circuitry that responds to and processes the basic instructions that drive the computing entity 200. Memory 304 may be defined as the integrated circuitry that stores information for immediate use in a computing entity 200. A peripheral device 270 may be defined as any hardware used by a user 405 and/or the computing entity 200 to facilitate communicate between the two. A storage device 250 may be defined as a device used to provide mass storage to a computing entity 200. A communication interface 280 may be defined as any transceiver-like device that enables the computing entity 200 to communicate with other devices and/or computing entities 200.

The bus 210 may comprise a high-speed interface 308 and/or a low-speed interface 312 that connects the various components together in a way such they may communicate with one another. A high-speed interface 308 manages bandwidth-intensive operations for computing device 300, while a low-speed interface 312 manages lower bandwidth-intensive operations. In some preferred embodiments, the high-speed interface 308 of a bus 210 may be coupled to the memory 304, display 316, and to high-speed expansion ports 310, which may accept various expansion cards such as a graphics processing unit (GPU). In other preferred embodiments, the low-speed interface 312 of a bus 210 may be coupled to a storage device 250 and low-speed expansion ports 314. The low-speed expansion ports 314 may include various communication ports, such as USB, Bluetooth, Ethernet, wireless Ethernet, etc. Additionally, the low-speed expansion ports 314 may be coupled to one or more peripheral devices 270, such as a keyboard, pointing device, scanner, and/or a networking device, wherein the low-speed expansion ports 314 facilitate the transfer of input data from the peripheral devices 270 to the processor 220 via the low-speed interface 312.

The processor 220 may comprise any type of conventional processor or microprocessor that interprets and executes computer readable instructions. The processor 220 is configured to perform the operations disclosed herein based on instructions stored within the system 400. The processor 220 may process instructions for execution within the computing entity 200, including instructions stored in memory 304 or on a storage device 250, to display graphical information for a graphical user interface (GUI) on an external peripheral device 270, such as a display 316. The processor 220 may provide for coordination of the other components of a computing entity 200, such as control of user interfaces 411, applications run by a computing entity 200, and wireless communication by a communication interface 280 of the computing entity 200. The processor 220 may be any processor or microprocessor suitable for executing instructions. In some embodiments, the processor 220 may have a memory device therein or coupled thereto suitable for storing the data, content, or other information or material disclosed herein. In some instances, the processor 220 may be a component of a larger computing entity 200. A computing entity 200 that may house the processor 220 therein may include, but are not limited to, laptops, desktops, workstations, personal digital assistants, servers 110, mainframes, cellular telephones, tablet computers, smart televisions, streaming devices, or any other similar device. Accordingly, the inventive subject matter disclosed herein, in full or in part, may be implemented or utilized in devices including, but are not limited to, laptops, desktops, workstations, personal digital assistants, servers 110, mainframes, cellular telephones, tablet computers, smart televisions, streaming devices, or any other similar device.

Memory 304 stores information within the computing device 300. In some preferred embodiments, memory 304 may include one or more volatile memory units. In another preferred embodiment, memory 304 may include one or more non-volatile memory units. Memory 304 may also include another form of computer-readable medium, such as a magnetic, solid state, or optical disk. For instance, a portion of a magnetic hard drive may be partitioned as a dynamic scratch space to allow for temporary storage of information that may be used by the processor 220 when faster types of memory, such as random-access memory (RAM), are in high demand. A computer-readable medium may refer to a non-transitory computer-readable memory device. A memory device may refer to storage space within a single storage device 250 or spread across multiple storage devices 250. The memory 304 may comprise main memory 230 and/or read only memory (ROM) 240. In a preferred embodiment, the main memory 230 may comprise RAM or another type of dynamic storage device 250 that stores information and instructions for execution by the processor 220. ROM 240 may comprise a conventional ROM device or another type of static storage device 250 that stores static information and instructions for use by processor 220. The storage device 250 may comprise a magnetic and/or optical recording medium and its corresponding drive.

As mentioned earlier, a peripheral device 270 is a device that facilitates communication between a user 405 and the processor 220. The peripheral device 270 may include, but is not limited to, an input device 408 and/or an output device 910. As used herein, an input device 408 may be defined as a device that allows a user 405 to input data and instructions that is then converted into a pattern of electrical signals in binary code that are comprehensible to a computing entity 200. An input device 408 of the peripheral device 270 may include one or more conventional devices that permit a user 405 to input information into the computing entity 200, such as a controller, scanner, phone, camera, scanning device, keyboard, a mouse, a pen, voice recognition and/or biometric mechanisms, etc. As used herein, an output device 910 may be defined as a device that translates the electronic signals received from a computing entity 200 into a form intelligible to the user 405. An output device 910 of the peripheral device 270 may include one or more conventional devices that output information to a user 405, including a display 316, a printer, a speaker, an alarm, a projector, etc. Additionally, storage devices 250, such as CD-ROM drives, and other computing entities 200 may act as a peripheral device 270 that may act independently from the operably connected computing entity 200. For instance, a streaming device may transfer data to a smartphone, wherein the smartphone may use that data in a manner separate from the streaming device.

The storage device 250 is capable of providing the computing entity 200 mass storage. In some embodiments, the storage device 250 may comprise a computer-readable medium such as the memory 304, storage device 250, or memory 304 on the processor 220. A computer-readable medium may be defined as one or more physical or logical memory devices and/or carrier waves. Devices that may act as a computer readable medium include, but are not limited to, a hard disk device, optical disk device, tape device, flash memory or other similar solid-state memory device, or an array of devices, including devices in a storage area network or other configurations. Examples of computer-readable mediums include, but are not limited to, magnetic media such as hard disks, floppy disks, and magnetic tape; optical media such as CD ROM discs and DVDs; magneto-optical media such as optical discs; and hardware devices that are specially configured to store and perform programming instructions, such as ROM 240, RAM, flash memory, and the like.

In an embodiment, a computer program may be tangibly embodied in the storage device 250. The computer program may contain instructions that, when executed by the processor 220, performs one or more steps that comprise a method, such as those methods described herein. The instructions within a computer program may be carried to the processor 220 via the bus 210. Alternatively, the computer program may be carried to a computer-readable medium, wherein the information may then be accessed from the computer-readable medium by the processor 220 via the bus 210 as needed. In a preferred embodiment, the software instructions may be read into memory 304 from another computer-readable medium, such as data storage device 250, or from another device via the communication interface 280. Alternatively, hardwired circuitry may be used in place of or in combination with software instructions to implement processes consistent with the principles as described herein. Thus, implementations consistent with the invention as described herein are not limited to any specific combination of hardware circuitry and software.

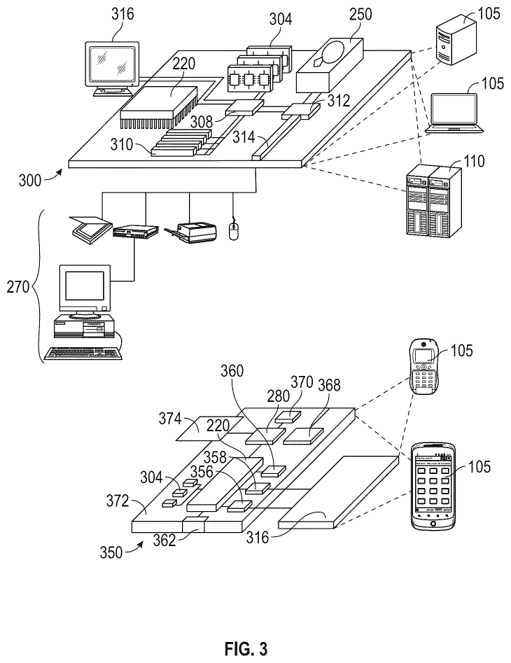

FIG. 3 depicts exemplary computing entities 200 in the form of a computing device 300 and mobile computing device 350, which may be used to carry out the various embodiments of the invention as described herein. A computing device 300 is intended to represent various forms of digital computers, such as laptops, desktops, workstations, servers 110, databases 115, mainframes, and other appropriate computers. A mobile computing device 350 is intended to represent various forms of mobile devices, such as scanners, scanning devices, personal digital assistants, cellular telephones, smart phones, tablet computers, and other similar devices. The various components depicted in FIG. 3, as well as their connections, relationships, and functions are meant to be examples only, and are not meant to limit the implementations of the invention as described herein. The computing device 300 may be implemented in a number of different forms, as shown in FIGS. 1 and 3. For instance, a computing device 300 may be implemented as a server 110 or in a group of servers 110. Computing devices 300 may also be implemented as part of a rack server system. In addition, a computing device 300 may be implemented as a personal computer, such as a desktop computer or laptop computer. Alternatively, components from a computing device 300 may be combined with other components in a mobile device, thus creating a mobile computing device 350. Each mobile computing device 350 may contain one or more computing devices 300 and mobile devices, and an entire system may be made up of multiple computing devices 300 and mobile devices communicating with each other as depicted by the mobile computing device 350 in FIG. 3. The computing entities 200 consistent with the principles of the invention as disclosed herein may perform certain receiving, communicating, generating, output providing, correlating, and storing operations as needed to perform the various methods as described in greater detail below.

In the embodiment depicted in FIG. 3, a computing device 300 may include a processor 220, memory 304 a storage device 250, high-speed expansion ports 310, low-speed expansion ports 314, and bus 210 operably connecting the processor 220, memory 304, storage device 250, high-speed expansion ports 310, and low-speed expansion ports 314. In one preferred embodiment, the bus 210 may comprise a high-speed interface 308 connecting the processor 220 to the memory 304 and high-speed expansion ports 310 as well as a low-speed interface 312 connecting to the low-speed expansion ports 314 and the storage device 250. Because each of the components are interconnected using the bus 210, they may be mounted on a common motherboard as depicted in FIG. 3 or in other manners as appropriate. The processor 220 may process instructions for execution within the computing device 300, including instructions stored in memory 304 or on the storage device 250. Processing these instructions may cause the computing device 300 to display graphical information for a GUI on an output device 910, such as a display 316 coupled to the high-speed interface 308. In other implementations, multiple processors and/or multiple buses may be used, as appropriate, along with multiple memory units and/or multiple types of memory. Additionally, multiple computing devices may be connected, wherein each device provides portions of the necessary operations.

A mobile computing device 350 may include a processor 220, memory 304 a peripheral device 270 (such as a display 316, a communication interface 280, and a transceiver 368, among other components). A mobile computing device 350 may also be provided with a storage device 250, such as a micro-drive or other previously mentioned storage device 250, to provide additional storage. Preferably, each of the components of the mobile computing device 350 are interconnected using a bus 210, which may allow several of the components of the mobile computing device 350 to be mounted on a common motherboard as depicted in FIG. 3 or in other manners as appropriate. In some implementations, a computer program may be tangibly embodied in an information carrier. The computer program may contain instructions that, when executed by the processor 220, perform one or more methods, such as those described herein. The information carrier is preferably a computer-readable medium, such as memory, expansion memory 374, or memory 304 on the processor 220 such as ROM 240, that may be received via the transceiver or external interface 362. The mobile computing device 350 may be implemented in a number of different forms, as shown in FIG. 3. For example, a mobile computing device 350 may be implemented as a cellular telephone, part of a smart phone, personal digital assistant, or other similar mobile device.

The processor 220 may execute instructions within the mobile computing device 350, including instructions stored in the memory 304 and/or storage device 250. The processor 220 may be implemented as a chipset of chips that may include separate and multiple analog and/or digital processors. The processor 220 may provide for coordination of the other components of the mobile computing device 350, such as control of the user interfaces 411, applications run by the mobile computing device 350, and wireless communication by the mobile computing device 350. The processor 220 of the mobile computing device 350 may communicate with a user 405 through the control interface 358 coupled to a peripheral device 270 and the display interface 356 coupled to a display 316. The display 316 of the mobile computing device 350 may include, but is not limited to, Liquid Crystal Display (LCD), Light Emitting Diode (LED) display, Organic Light Emitting Diode (OLED) display, and Plasma Display Panel (PDP), or any combination thereof. The display interface 356 may include appropriate circuitry for causing the display 316 to present graphical and other information to a user 405. The control interface 358 may receive commands from a user 405 via a peripheral device 270 and convert the commands into a computer readable signal for the processor 220. In addition, an external interface 362 may be provided in communication with processor 220, which may enable near area communication of the mobile computing device 350 with other devices. The external interface 362 may provide for wired communications in some implementations or wireless communication in other implementations. In a preferred embodiment, multiple interfaces may be used in a single mobile computing device 350 as is depicted in FIG. 3.

Memory 304 stores information within the mobile computing device 350. Devices that may act as memory 304 for the mobile computing device 350 include, but are not limited to computer-readable media, volatile memory, and non-volatile memory. Expansion memory 374 may also be provided and connected to the mobile computing device 350 through an expansion interface 372, which may include a Single In-Line Memory Module (SIM) card interface or micro secure digital (Micro-SD) card interface. Expansion memory 374 may include, but is not limited to, various types of flash memory and non-volatile random-access memory (NVRAM). Such expansion memory 374 may provide extra storage space for the mobile computing device 350. In addition, expansion memory 374 may store computer programs or other information that may be used by the mobile computing device 350. For instance, expansion memory 374 may have instructions stored thereon that, when carried out by the processor 220, cause the mobile computing device 350 perform the methods described herein. Further, expansion memory 374 may have secure information stored thereon; therefore, expansion memory 374 may be provided as a security module for a mobile computing device 350, wherein the security module may be programmed with instructions that permit secure use of a mobile computing device 350. In addition, expansion memory 374 having secure applications and secure information stored thereon may allow a user 405 to place identifying information on the expansion memory 374 via the mobile computing device 350 in a non-hackable manner.

A mobile computing device 350 may communicate wirelessly through the communication interface 280, which may include digital signal processing circuitry where necessary. The communication interface 280 may provide for communications under various modes or protocols, including, but not limited to, Global System Mobile Communication (GSM), Short Message Services (SMS), Enterprise Messaging System (EMS), Multimedia Messaging Service (MMS), Code Division Multiple Access (CDMA), Time Division Multiple Access (TDMA), Personal Digital Cellular (PDC), Wideband Code Division Multiple Access (WCDMA), IMT Multi-Carrier (CDMAX 0), and General Packet Radio Service (GPRS), or any combination thereof. Such communication may occur, for example, through a transceiver 368. Short-range communication may occur, such as using a Bluetooth, WIFI, or other such transceiver 368. In addition, a Global Positioning System (GPS) receiver module 370 may provide additional navigation-and location-related wireless data to the mobile computing device 350, which may be used as appropriate by applications running on the mobile computing device 350. Alternatively, the mobile computing device 350 may communicate audibly using an audio codec 360, which may receive spoken information from a user 405 and covert the received spoken information into a digital form that may be processed by the processor 220. The audio codec 360 may likewise generate audible sound for a user 405, such as through a speaker, e.g., in a handset of mobile computing device 350. Such sound may include sound from voice telephone calls, recorded sound such as voice messages, music files, etc. Sound may also include sound generated by applications operating on the mobile computing device 350.

The system 400 may also comprise a power supply. The power supply may be any source of power that provides the system 400 with power. In an embodiment, the power supply may be a stationary power source. For instance, the system may be hardwired to the electrical circuitry of a host building to which said system is connected. Alternatively, the system may comprise a mobile power source, such as a mobile, gas-powered generator, which may allow the system to receive power when not connected to a stationary power source. In some embodiments, the system 400 may comprise multiple power supplies that may provide power to the system 400 in different circumstances. For instance, the system 400 may be directly connected to a stationary power source, such as one or more power outlets, which may provide power to the system 400 so long as it remains in one place. However, the system 400 may also be connected to a mobile power source, such as backup battery or a generator, so that the system 400 may receive power even when not connected to a stationary power source or if the stationary power outlet to which the system is connected ceases to provide power to the system 400. In yet another preferred embodiment, a plurality of solar charging panels may be operably connected to a battery of the system, which may allow a user to place the system 400 in a location that may otherwise have no reasonable access to a stationary power source. In these ways, the system 400 may receive power so that it may be used in the various manners as described herein.

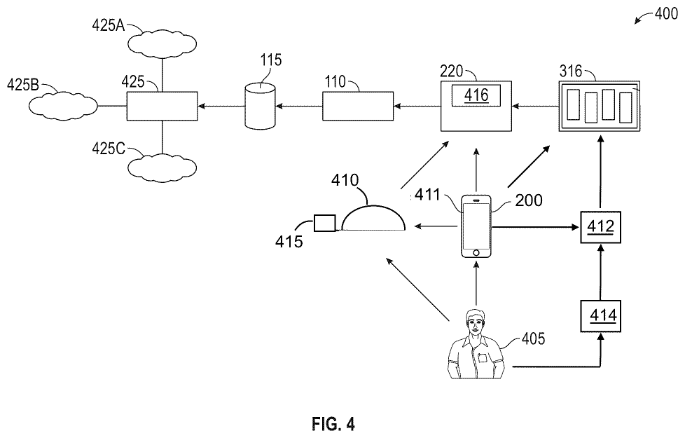

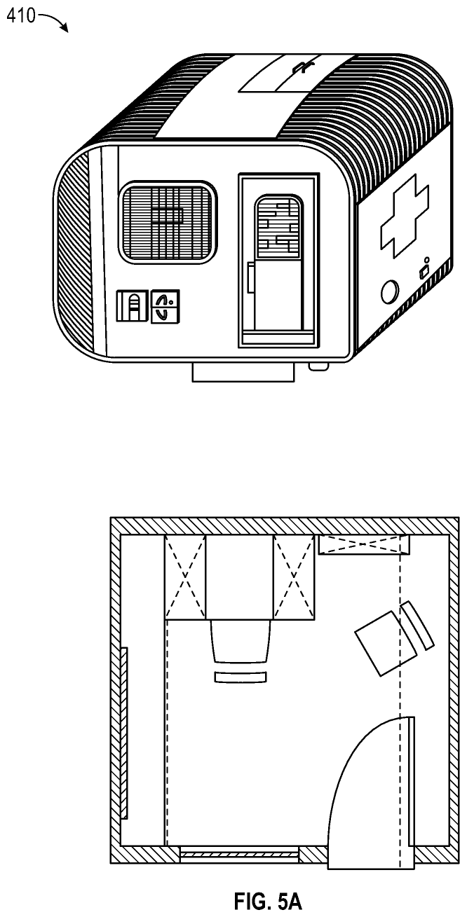

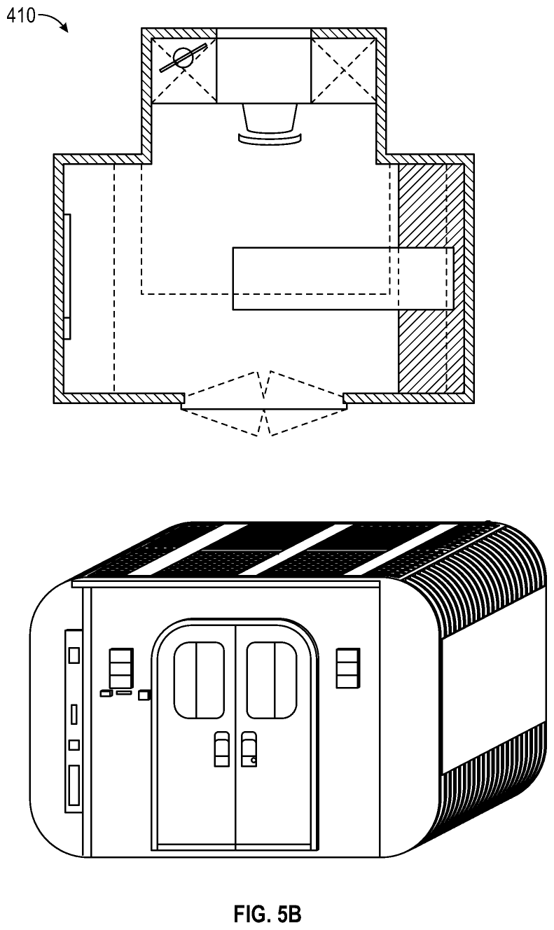

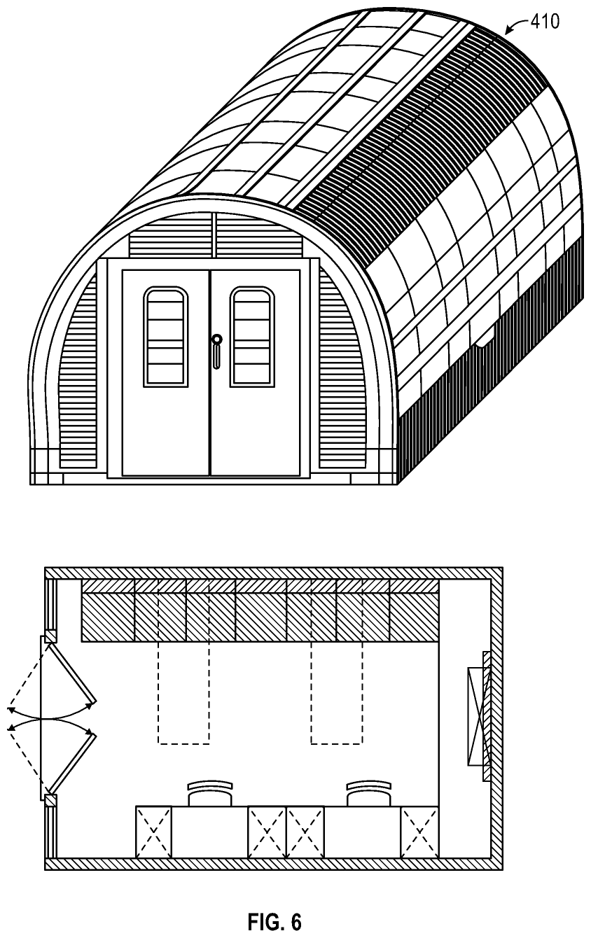

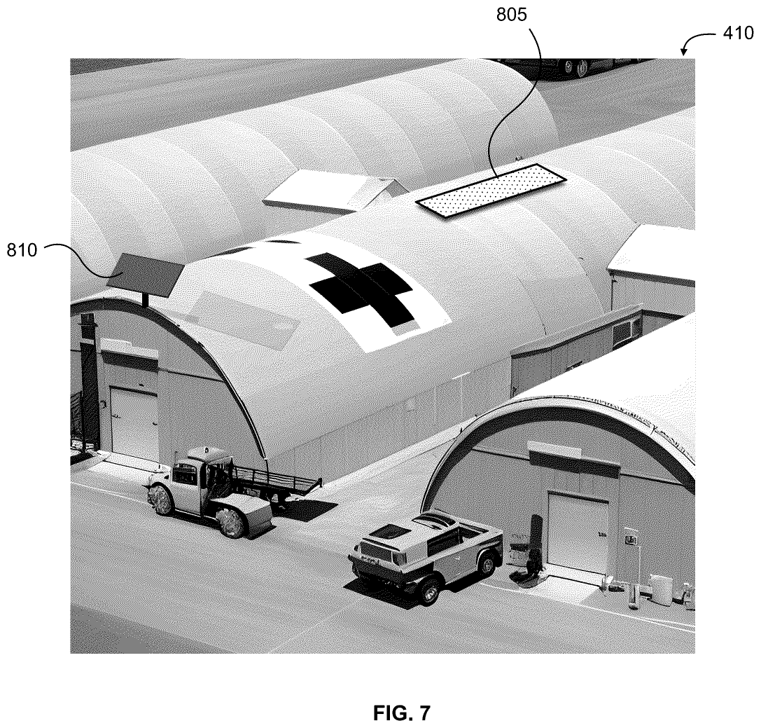

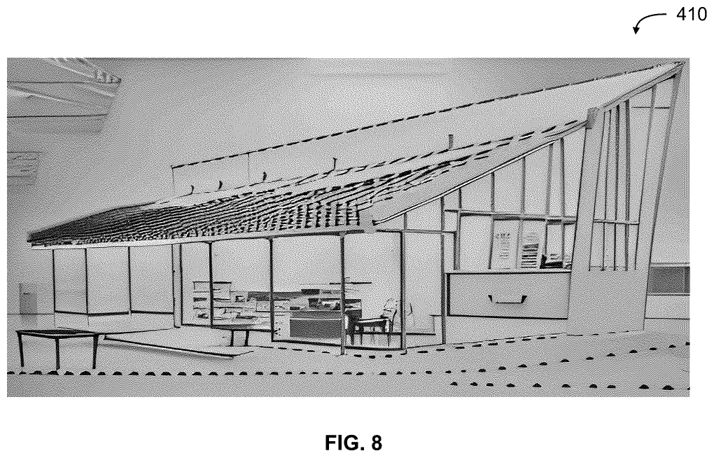

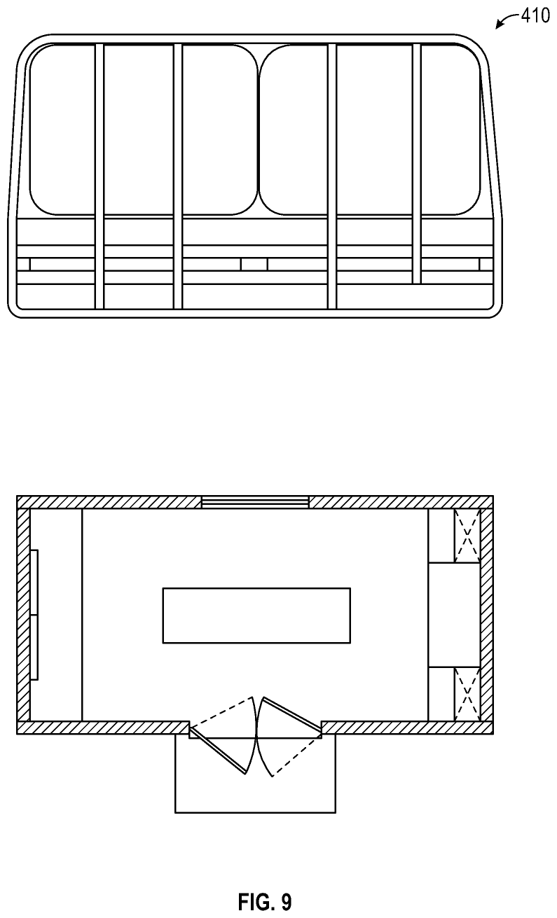

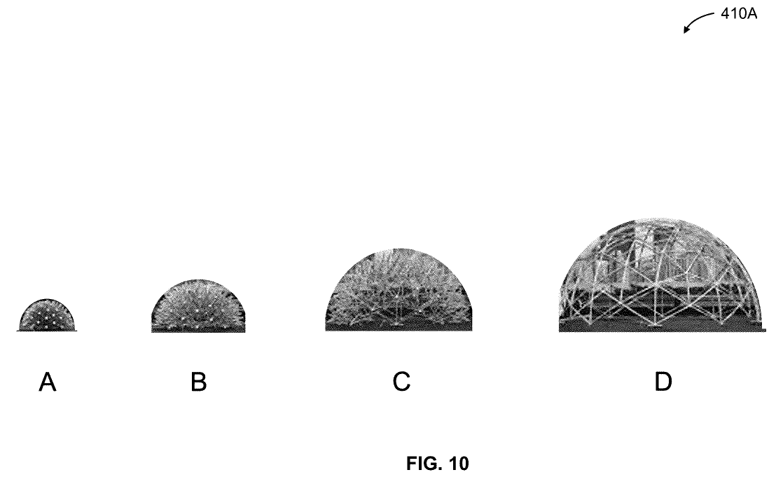

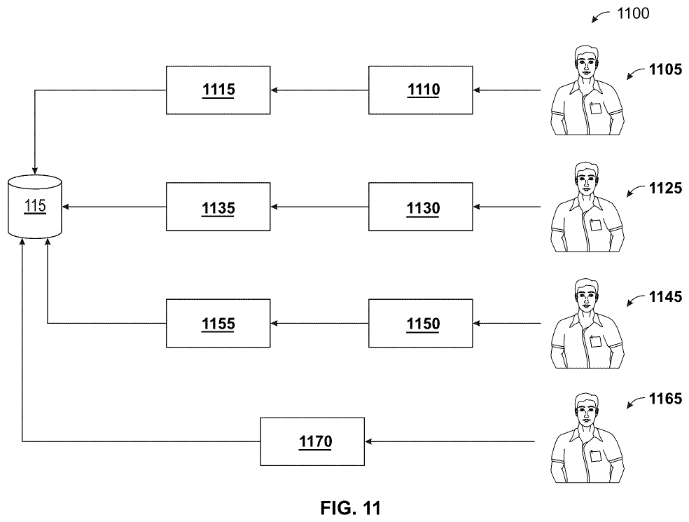

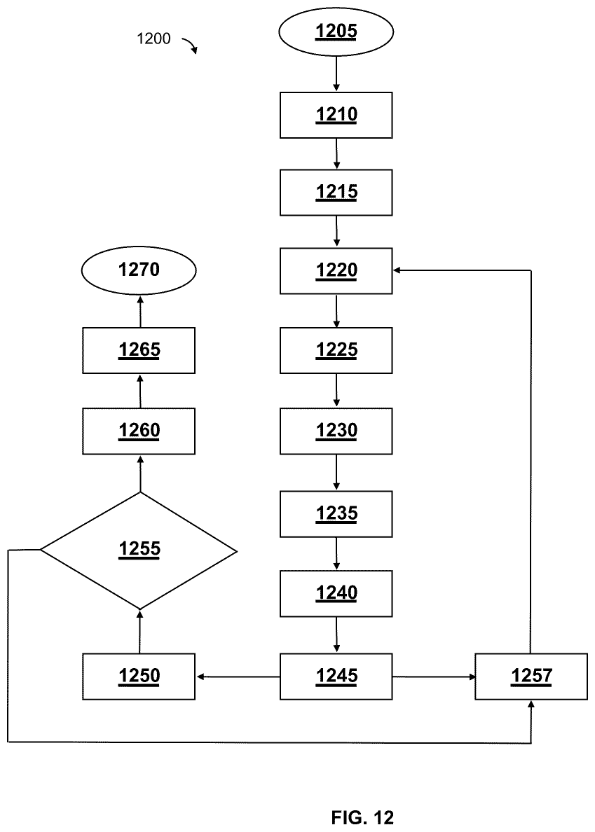

As will be evident from the disclosure provided, the present invention satisfies the need for a system 400 and method of a portable digital pod that can be quickly dispatched and setup to carry out tasks in which the portable digital pod is designed. FIGS. 4-12 illustrate embodiments of a portable digital pod system 400 and methods in which it may be used. FIG. 4 illustrates a portable digital pod system 400 that may be deployed in various environments for various purposes. FIGS. 5A and 5B illustrates a portable digital pod system 400 designed to assist healthcare personnel to carry out healthcare tasks. FIG. 6 illustrates a portable digital pod system 400 designed to assist military personnel to carry out military related tasks. FIG. 7 is a diagram illustrating a portable digital pod system 400 designed to assist emergency personnel to carry out emergency related tasks. FIG. 8 illustrates a portable digital pod system 400 designed to assist retail personnel to carry out retail related tasks. FIG. 9 illustrates a portable digital pod system 400 in a collapsed position (top) and an expanded position (bottom). FIG. 10 illustrates a portable digital pod system 400 expanding from a collapsed position to an expanded position. FIG. 11 illustrates permission levels 1100 that may be utilized by the present portable digital pod system 400 for controlling access to user content 1115, 1135, 1155 such as user data 425A, image data 425B, log data 425C. FIG. 12 illustrates a method that may be carried out by a user 405 to setup the portable digital pod system 400. It is understood that the various method steps associated with the methods of the present disclosure may be carried out as operations by the portable digital pod system 400 shown in FIGS. 4-10.

As illustrated in FIG. 4, the system 400 generally comprises collapsible pod 410, display 316, computing entity 200, processor 220 operably connected to the display 316 and computing entity 200, and a non-transitory computer-readable medium 416 having instructions stored thereon. In a preferred embodiment, the collapsible pod 410 is extended and collapsed by way of a hydraulic/pneumatic pack 415 that operably secures to a hydraulic/pneumatic arm of the collapsible pod 410, which may then be locked into place causing the collapsible pod 410 to be locked into an extended or collapsed position. Once locked, the hydraulic/pneumatic pack 415 may be disengaged therefrom so that said hydraulic/pneumatic pack 415 may be used for other purposes, such as extending or collapsing other collapsible pods 410. For instance, a plurality of collapsible pods 410 and a single hydraulic/pneumatic pack 415 may be deployed in an emergency zone, wherein said single hydraulic/pneumatic pack 415 may be used to expand each collapsible pod 410 of the plurality collapsible pods 410. This may not only reduce the cost of such a deployment but also reduce the number of moving parts prone to failure. However, in some embodiments, the collapsible pod 410 may be manually expanded and contracted by a user 405.

In another preferred embodiment, a database 115 may be operably connected to the processor, and the various data of the system 400 may be stored therein, including, but not limited to, user data 425A, image data 425B, and log data 425C. Further, some embodiment of the system 400 may comprise a server used to facilitate the transfer of data between the computing entity 200, display 316, and/or database 115. In some preferred embodiments, a display user interface of the display 316 may be configured to present data therein, wherein a control board 412 of the display 316 may be configured to receive said data from the computing entity 200, database 115, and/or server. In yet other preferred embodiments, a wireless communication interface may allow the processors 220 of the system 400 to receive and transmit image data 425B therebetween. Some embodiments of the system 400 may comprise a user interface 411 of the computing entity 200 that allows users 405 to coordinate with the display 316 in order to disseminate information via the display user interface in the manners described herein. Further, the computing entity 200 may allow a user 405 to manage data of the system 400 and/or control the position of the collapsible pod 410 until said collapsible pod 410 is placed in a desired position. Further, some preferred embodiments of the system 400 may comprise security features that may prevent the unwanted access of third parties to information of the system 400 and/or the interior of the collapsible pod 410.

In a preferred embodiment, the collapsible pod 410 comprises a framework 410A and exterior shell 410B. The collapsible pod 410 may also comprise at least one hydraulic/pneumatic arm 410C operably connected to said exterior shell 410B and/or framework 410A, which may be used to expand or contract the collapsible pod 410. In embodiments comprising a hydraulic/pneumatic arm 410C, the framework 410A is configured to expand until it reaches an extended position as the hydraulic/pneumatic arm 410C extends, wherein a fully extended hydraulic/pneumatic arm 410C coincides with the collapsible pod 410 being placed in an extended position. Joints of the framework 410A may allow said framework 410A to take on the various shapes described herein. In one preferred embodiment, the joints of the framework 410A are a plurality of prismatic revolute joints that create an isokinetic structure that can take on a size much smaller when placed in the collapsed position compared to when placed in the extended position. For instance, as illustrated in FIG. 10, a plurality of portable digital pods in the form of isokinetic structures may be deployed in a collapsed position (A) to an area affected by a natural disaster before being placed in an extended position (D) and used for medical, shelter, nourishment, and search/rescue stations for victims of said natural disaster. Alternatively, the joints may act in conjunction with a gear and pulley system 400, such as a block and tackle, to pull the move the various pieces of the frame until it is placed in an extended position, as illustrated in A-D in FIG. 10.

The exterior shell 410B is connected to the framework 410A and is strategically attached to the framework 410A in a way that allows the collapsible pod 410 to extend and collapse. In one preferred embodiment, the framework 410A is a large, interconnected structure that expands or contracts as one piece. For instance, the system 400 may comprise a framework 410A that takes the shape of a large geodesic dome as the hydraulic/pneumatic arm 410C extends to place said framework 410A in an extended position. In another preferred embodiment, the framework 410A may comprise multiple framework units that may be added or subtracted depending on system 400 design. These framework units may then be extended and collapsed separately, allowing for more flexibility for structure design. For instance, the system 400 may comprise a first framework unit, second framework unit, and third framework unit, wherein said first framework unit, second framework 410A, and third framework unit may be separately or simultaneously extended by a user 405 to force their respective frameworks 410A to take on cylindrical, Quonset, and rectangular shaped structures configured to a form a single, interconnected structure. Preferably, the exterior shell 410B is pulled taut as the framework 410A expands, creating an interior space within the collapsible pod 410 that contains many of the computing components of the system 400.

In one preferred embodiment, the exterior shell 410B makes up the exterior structure of the collapsible pod 410 and may be manipulated by the framework 410A and/or hydraulic/pneumatic arm 410C of the system 400. The exterior shell 410B may comprise one piece or a plurality of pieces. In embodiments in which the exterior shell 410B comprises a plurality of pieces, each piece of the plurality of pieces of the exterior shell 410B is preferably connected to other pieces in a way such that the exterior structure is fully formed when the collapsible pod 410 is fully placed in an extended position, as illustrated in FIGS. 5A-10. In a preferred embodiment, the exterior shell 410B comprises a flexible material configured to tightly fit the framework 410A as it expands; however, the system 400 may also comprise an exterior shell 410B composed of a rigid material or a combination of rigid material and flexible material without departing from the inventive subject matter described herein. For instance, as illustrated in FIG. 6, a collapsible pod 410 created for military use may comprise an exterior shell 410B composed of a flexible Kevlar infused fabric with steel plates sewn therein to provide level three ballistic protection in hostile environments. For instance, as illustrated in FIG. 7, a plurality of rigid insulated panels may be manipulated by the frame in a way such that a rigid exterior structure protects the interior of the collapsible pod 410 from harsh environmental elements when placed in an extended position.

In another preferred embodiment, the exterior shell may comprise a rigid, projectile resistant material. For instance, a plurality of exterior panels secured to the framework may be configured to resist bullets and shrapnel. In a preferred embodiment, a fiberglass panel or Kevlar infused panel may be used to provide projectile resistance to the portable digital pod system. In another preferred embodiment, steel plates or a steel mesh may be secured to or incorporated into the exterior shell to provide resistance to projectiles. In one preferred embodiment, the exterior shell may comprise at least two layers of projectile resistance. For instance, a first layer of projectile resistant paneling may be covered with a Kevlar infused camouflage jacket, which will not only increase projectile resistance but also make the portable digital pod system more difficult to see. In a preferred embodiment, the jacket is fitted so that it snuggly secures about the exterior of the portable digital pod system.

In a preferred embodiment, the framework 410A and exterior shell 410B comprises materials having a low fatigue limit, which may prevent the system 400 from deteriorating due to the stresses that may be experienced while unfolding into an open position and folding into a closed position. This low fatigue limit is important for applications the system 400 may be deployed and undeployed multiple times in a short time period. However, one with skill in the art may recognize that the framework 410A and exterior shell 410B may comprise of any material suitable for a folding structure without departing from inventive subject matter described herein. In another preferred embodiment, the material of the exterior shell may comprise a radio frequency shielding material, such as Faraday cloth or sheets of copper, nickel, aluminum, and other material suitable for creating a Faraday cage. This material may also be used to protect against high-altitude electromagnetic pulses (HEMPs) and related occurrences, such as coronal mass ejections (CMEs), electrostatic discharges (ESDs), and solar flares. This could be particularly useful for military and law enforcement since it can block all wireless signals, including cell phone, WiFi, Bluetooth, and GPS. Additionally, this material could be used for protecting personal data and identity, signal isolation in secure facilities, RF isolation for hardware and software testing, harmful EMF radiation reduction, anti-credit card skimming, digital privacy.

In some preferred embodiments, at least one hydraulic/pneumatic arm 410C alters a position of said framework 410A, thus changing the position of the collapsible pod 410. In one preferred embodiment, the at least one hydraulic/pneumatic arm 410C is moveably connected to the framework 410A in a way such that manipulation of one side of the framework 410A by the hydraulic/pneumatic arm 410C may cause the entire framework 410A to be manipulated until a desired position is achieved. For instance, a system 400 comprising a frame having a block and tackle pulley system and plurality of joints, and hydraulic/pneumatic arm 410C may have said block and tackle pulley system operably connected to the hydraulic/pneumatic arm 410C in way that allows a user 405 to place the collapsible pod 410 in an extended position and collapsed position simply by manipulating the hydraulic/pneumatic arm 410C.

In another preferred embodiment, the collapsible pod 410 may comprise more than one hydraulic/pneumatic arm that is connected to the framework units of the system 400. For instance, a first framework 410A of a collapsible pod 410 having a first hydraulic/pneumatic arm and a second framework 410A of said collapsible pod 410 having a second hydraulic/pneumatic arm may be secured to different hydraulic/pneumatic packs 415 that may be used to independently place the first framework and second framework in extended and collapsed positions by a user 405, allowing a user 405 to collapse/expand certain areas of the collapsible pod 410 as needed. For instance, a system 400 comprising a top framework 410A, bottom framework 410A, and at least one middle framework 410A may have separate hydraulic/pneumatic arms that connect to separate hydraulic/pneumatic packs 415, which allows a user 405 to create larger collapsible pod 410 structures in sections so that a smaller hydraulic/pneumatic pack 415 may be used to place said larger collapsible pod 410 structure in the desired position than might otherwise be possible. Therefore, the collapsible pod 410 may comprise one or more framework units having one or more hydraulic/pneumatic arms that may be manipulated by one or more hydraulic/pneumatic packs 415, allowing for flexibility in design depending on the application for which the portable digital pod system 400 is to be deployed.

In a preferred embodiment, the hydraulic/pneumatic arms 410C are actuators configured to be powered by a hydraulic/pneumatic pack 415. In a preferred embodiment, the hydraulic/pneumatic pack 415 may comprise an engine, hydraulic/pneumatic pump, hydraulic reservoir, hydraulic/pneumatic fluid, control valves, user control, plurality of seals, and plurality of tubes that connect to the hydraulic/pneumatic pump to the actuator. The hydraulic/pneumatic pump supplies the hydraulic/pneumatic fluid to the various components of the actuator. The hydraulic pump supplies the hydraulic fluid to the hydraulic/pneumatic arms 410C. The control valves direct the hydraulic fluid to hydraulic/pneumatic arms 410C via the plurality of tubes. In a preferred embodiment, a computing entity 200 is operably connected to the control valves in a way such that a user 405 may operate the computing entity 200 to instruct the control valves which route through the plurality of tubes the hydraulic fluid may take to the hydraulic/pneumatic arms 410C, wherein the work force generated by the pressure changes caused by the hydraulic fluid cause the hydraulic/pneumatic arms 410C to manipulate the framework 410A of the collapsible pod 410. The hydraulic reservoir holds hydraulic fluid not currently being used to operate the actuator. The plurality of seals prevents the escape of hydraulic fluid from the hydraulic device.

In a preferred embodiment, the hydraulic/pneumatic arm 410C comprises a hydraulic cylinder defined by an internal cavity, a slidably moveable piston disposed within the internal cavity, and a strut operably connected to the slidably moveable piston. The slidably moveable piston may be shaped in a way such that it creates two chambers within the cavity. In a preferred embodiment, the hydraulic cylinder may be operably connected to the linear actuator in a way such that the direction of rotation of the pinion manipulates the control valve so that it directs hydraulic fluid pumped by the hydraulic pump into one of a first chamber or a second chamber of the hydraulic cylinder. Pressure change resulting from hydraulic fluid being injected into the first chamber or second chamber acts on the slidably moveable piston, causing the slidably moveable piston to move in a direction from higher pressure to lower pressure. The strut is projected out the strut end of the hydraulic/pneumatic arm 410C and is coupled to the framework 410A and/or gear and pulley mechanism. Operating the hydraulic device to cause the slidably moveable piston to move in a direction from higher pressure to lower pressure causes the strut to move in a linear direction, which in turn causes the framework 410A to change position.

In another preferred embodiment, the control arm is a folding arm comprising a plurality of arm units and a plurality of joints. The hydraulic/pneumatic pack 415 is operably connected to the folding arm in a way such that the strut may extend or fold the arm units. Therefore, the folding arm may change the position of the framework 410A depending on the amount of force exerted by the foldable arm on the framework 410A and the angle in which said force is exerted. For instance, a system 400 comprising a folding arm having a top arm unit and bottom arm unit connected by joints may be extended from a folded position to a linear position by extending the strut of the hydraulic device, thus raising the framework 410A to which the folding arm is attached. For instance, a system 400 comprising a plurality of folding arms secured to a plurality of gear and pulley mechanisms of a plurality of framework units may be able to place a collapsible pod 410 into a partially extended/collapsed position, depending on which folding arms are placed in the extended/collapsed position.

The system 400 may also comprise a locking mechanism, wherein said locking mechanism may be used to lock the framework 410A and/or hydraulic/pneumatic arms 410C in place, thus securing the collapsible pod 410 in an extended or collapsed position. For instance, a system 400 having a hydraulic/pneumatic arm 410C that places a collapsible pod 410 in the form of a retail store in an extended position, as illustrated in FIG. 8, may be locked via said locking mechanism to prevent said collapsible pod 410 from moving to a collapsed position. In one preferred embodiment, the locking mechanism is a mechanical fastener. A mechanical fastener may include, but is not limited to, rivets, screws, nails, bolts, or any combination thereof. In another preferred embodiment, the hydraulic/pneumatic arm 410C itself may be locked into a desired position simply using the hydraulic/pneumatic fluid of the hydraulic/pneumatic pack 415, which in turn locks the collapsible pod 410 created by the framework 410A and exterior shell 410B into the extended position. In yet another preferred embodiment, an electronic lock may be used to lock the hydraulic/pneumatic arms 410C of the portable digital pod system 400 in place. A computer readable signal or electric current sent by the user 405 via a computing device or switch, respectively, may activate/deactivate the electronic lock. For instance, a user 405 may choose to deactivate an electronic lock operably connected to hydraulic/pneumatic arms 410C using a user interface 411 of a computing entity 200 operably connected to the hydraulic/pneumatic arm 410C, wherein said computing entity 200 sends a computer readable signal to the electronic lock instructing it to deactivate, thus causing the hydraulic/pneumatic arm 410C to be unlocked so that it may be used to place the collapsible pod 410 in an extended position or collapsed position.

The joints of the system 400 allow the hydraulic/pneumatic arms 410C and/or framework 410A to extend and contract at various angles. For instance, as illustrated in FIGS. 5A-10, a system 400 may comprise a hydraulic/pneumatic arm 410C and/or framework 410A that comprise a plurality of joints, wherein said hydraulic/pneumatic arm 410C and framework 410A largely contract and expand about said joints, resulting in a collapsed size of a collapsible pod 410 that takes up very few cubic feet of space relative to an extended size of a collapsible pod 410. In one preferred embodiment, the framework 410A comprises a plurality of Hoberman linkages comprising two angulated ridged bars connected at a central point by a revolute joint, making it move much like a scissor mechanism. This may allow the framework 410A to shrink and/or expand to smaller and larger structures. A Hoberman linkage may also allow for a single hydraulic/pneumatic arm 410C to cause the entire collapsible pod 410 to be manipulated between an extended position and collapsed position since the scissor like action of the Hoberman linkages turns linear motion from a single axis of a joint into radial motion across the entire framework 410A of Hoberman linkages. For instance, a system 400 comprising a single framework 410A comprising a plurality of Hoberman linkages may be changed from a collapsed position to an extended position by causing a hydraulic/pneumatic arm 410C to exert a work force that forces the framework 410A away from a central point within said framework 410A.

In a preferred embodiment, the various data of the system 400 may be stored in user profiles 425. Types of data that may be stored within user profiles 425 of the system 400 include, but are not limited to, user data 425A, image data 425B, and log data 425C. One preferred embodiment of the system 400 may comprise a database 115 operably connected to the processor 220. The database 115 may be configured to store user data 425A, image data 425B, and log data 425C within said user profiles 425. As used herein, user data 425A may be defined as personal information of a user 405 that helps the system 400 identify the user 405. Types of data that may be used by the system 400 as user data 425A includes, but is not limited to, a user's name, username, social security number, phone number, gender, age, or any combination thereof. The database 115 may also act as a distributor of image data 425B to the display user interface of a display 316. Alternatively, the processor 220 and/or database 115 may transmit image data 425B to a server 110, which may act as a distributor of image data 425B to the display user interface of a display 316. In a preferred embodiment, a user profile 425 is related to a particular user 405. A user 405 is preferably associated with a particular user profile 425 based on a username. However, it is understood that a user 405 may be associated with a user profile 425 using a variety of methods without departing from the inventive subject matter herein.

The display 316 of the system 400 is preferably connected to the frame and/or exterior shell 410B in a way such that a user 405 may view the display 316 only from the interior of the collapsible pod 410. Due to the folding nature of the system 400, the display 316 preferably comprises a flexible screen. Types has displays 316 that may function as a flexible screen, include, but are not limited to, electronic ink, Gyricon, Organic LCD, and OLED, or any combination thereof. As previously mentioned, some preferred embodiments of the display 316 may further comprise a control board 412. The control board 412 comprises at least one circuit and microchip. In another preferred embodiment, the control board 412 may further comprise a wireless communication interface 280, which may allow the control board 412 to receive instructions from an input device controlled by a user 405. In a preferred embodiment, the control board 412 may control the display user interface and the image data 425B presented therein. The microchip of the control board 412 comprises a microprocessor and memory. In another preferred embodiment, the microchip may further comprise a wireless communication interface 280 in the form of an antenna. The microprocessor may be defined as a multipurpose, clock driven, register based, digital-integrated circuit which accepts binary data as input, processes it according to instructions stored in its memory, and provides results as output. In a preferred embodiment, the microprocessor may receive image data 425B from at least one computing entity 200 via the wireless communication interface 280. Some preferred embodiments of image data 425B may also include an audio data component.

As mentioned previously, the system 400 may further comprise at least one user interface 411. A user interface 411 may be defined as a space where interactions between a user 405 and the system 400 may take place. In an embodiment, the interactions may take place in a way such that a user 405 may control the operations of the system 400. A user interface 411 may include, but is not limited to operating systems, command line user interfaces, conversational interfaces, web-based user interfaces, zooming user interfaces, touch screens, task-based user interfaces, touch user interfaces, text-based user interfaces, intelligent user interfaces, brain-computer interfaces (BCIs), and graphical user interfaces, or any combination thereof. The system 400 may present data of the user interface 411 to the user 405 via a display 316 operably connected to the processor 220. A display 316 may be defined as an output device that communicates data that may include, but is not limited to, visual, auditory, cutaneous, kinesthetic, olfactory, and gustatory, or any combination thereof.

In a preferred embodiment, a control board 412 of the display 316 receives image data 425B from the computing entity 200. The control board 412 may then present said image data 425B via the display 316 in the display user interface. In one preferred embodiment, the image data 425B is streamed from the computing entity 200 to the control board 412, wherein the control board 412 inserts said streamed image data 425B into the display user interface. Alternatively, the control board 412 may manipulate the image data 425B and/or display user interface based on commands received from an input device. In one preferred embodiment, the display user interface may also comprise a control window, which may allow a user 405 to control the layout of the display user interface. For instance, a user 405 may choose to layout that separates the display user interface into multiple windows. Alternatively, an input device having a plurality of layouts thereon may be used to manipulate the layout of the display user interface. The input device may be connected to the system 400 via a wired or wireless connection. In a preferred embodiment, the input device communicates sends a computer readable signal containing instructions to the control board 412, which the control board 412 uses to manipulate the image data 425B and/or display user interface.

Information presented via a display 316 may be referred to as a soft copy of the information because the information exists electronically and is presented for a temporary period of time. Information stored on the non-transitory computer-readable medium 416 may be referred to as the hard copy of the information. For instance, a display 316 may present a soft copy of visual information via a liquid crystal display (LCD), wherein the hardcopy of the visual information is stored on a local hard drive. For instance, a display 316 may present a soft copy of audio information via a speaker, wherein the hard copy of the audio information is stored in RAM. For instance, a display 316 may present a soft copy of tactile information via a haptic suit, wherein the hard copy of the tactile information is stored within a database 115. Displays 316 may include, but are not limited to, cathode ray tube monitors, LCD monitors, light emitting diode (LED) monitors, gas plasma monitors, screen readers, speech synthesizers, haptic suits, virtual reality headsets, speakers, and scent generating devices, or any combination thereof.

The database 115 may be configured to store user data 425A, image data 425B, and log data 425C within user profiles 425. The processor 125 may be operably connected to the database 115 via wired or wireless connection. In a preferred embodiment, the database 115 may be configured to store a plurality of user profiles 425 therein and the various information, data, and/or content tied to or associated with such profiles. The database 115 may be a relational database such that the user data 425A, image data 425B, and log data 425C within a user profile 425 within the plurality user profiles 425 may be stored, at least in part, in one or more tables. Alternatively, the database 115 may be an object database such that the user data 425A, image data 425B, and log data 425C within a user profile 425 within the plurality of user profiles 425 may be stored, at least in part, as objects. In some instances, the database 115 may comprise a relational and/or object database and a server dedicated solely to managing the content assigned to user profiles 425 in the manner disclosed herein. Although the database 115 is represented as a single entity within FIG. 4, it is understood that data, information, and/or content stored within the database or repository, as disclosed herein, may be stored within a plurality of databases without departing from the inventive subject matter disclosed herein.

In one preferred embodiment, the system 400 may further comprise a secondary security device 414, such as a biometric scanner, camera configured to collect image data 425B for facial recognition, or bracelet having a unique identifier. In one preferred embodiment, the secondary security device 414 may be operably connected to a computing entity 200 and/or display 316 in a way such that it is in direct communication with the computing entity 200 and/or display 316 and no other computing entity 200 and/or display 316. For instance, the secondary security device 414 may be connected to a control board 412 of the display 316 such that a healthcare professional and patient must biometrically scan their thumbprint and/or face prior to the display 316 activating. This may serve as an additional precaution to prevent the unintentional sharing of legally protected health records of a patient. The computing entity 200, server 110, database 115, display 316, and secondary security device 414 may be connected via a wired or wireless connection. In a preferred embodiment, the computing entity 200, and display 316 are connected via a wireless connection, such as Bluetooth, whereas the secondary security device 414 has a wired connection with the computing entity 200 and/or display 316.

In another preferred embodiment, the secondary security device 414 may contain a transmitter containing a unique ID, which may be transmitted to a computing entity 200 and/or display 316 in the form of a computer readable signal before the system 400 determines if access to the system 400 will be granted. Unique IDs contained within the signal broadcast by the transmitter may include, but are not limited to, unique identifier codes, social security numbers, PINs, etc. For instance, a computer readable signal broadcast by a secondary security device 414 in the form of a bracelet may contain information that will alert the system 400 that a particular user 405 is within a certain range of a particular computing device, which may cause the system 400 to activate said particular computing device. Alternatively, the system 400 may be configured to prevent activation of a display 316 if a particular user 405 is within range. For instance, before conveying classified information to a group of military personnel, the system 400 may perform a query to determine if a user 405 is within range that doesn't have permissions to view said classified information. If a user 405 without an appropriate permission level is within range of the display 316, the display 316 will not activate.

Types of devices that may act as the transmitter include, but are not limited, to near field communication (NFC), Bluetooth, infrared (IR), radio-frequency communication (RFC), radio-frequency identification (RFID), and ANT+, or any combination thereof. In an embodiment, transmitters may broadcast signals of more than one type. For instance, a transmitter comprising an IR transmitter and RFID transmitter may broadcast IR signals and RFID signals. Alternatively, a transmitter may broadcast signals of only one type of signal. For instance, ID badges may be fitted with transmitters that broadcast only NFC signals containing unique IDs that computing devices equipped with NFC receivers must receive before being activated by a user 405.

In yet another preferred embodiment, the secondary security device 414 may comprise a predefined pattern that a user 405 must scan before the system 400 will allow said user 405 to activate the display 316. For instance, FEMA personnel wanting to access a drone of the system 400 so that an emergency search may be performed may have to scan a predefined pattern of a bracelet of higher-ranking FEMA personnel, which may then cause a drone control device connected to the FEMA personnel's computing device and higher-ranking FEMA personnel's computing device to activate. For instance, a retail professional in training wanting to access a point-of-sale system may be required to scan a predefined pattern of an ID badge using a scanning device of said point-of-sale system. Further, the system 400 may comprise a plurality of secondary security device 414s that may be used to protect users 405 of the system 400. For instance, the system 400 may use a combination of a biometric scanning device and a bracelet having a scannable predefined pattern 605 in addition to the methods of transmitting login credentials from a computing entity 200 in the manners described herein. Therefore, one with skill in the art will recognize that a plurality of methods may be used to secure information of the system 400 without departing from the inventive subject matter described herein.

In some preferred embodiments, the system 400 may capture an identifying address of any computing device connected thereto. An identifying address may include, but is not limited to, basic service set identifier (BSSID), extended service set identifier (ESSID), service set identifier (SSID), and media access control (MAC) address, or any combination thereof. For instance, the system 400 may capture a MAC address of a computing device wirelessly connected to the system 400 via Bluetooth. The system 400 may capture identifying addresses by actively scanning or passively scanning for computing devices capable of wirelessly connecting to the system 400. In another preferred embodiment, computing devices may be configured to send a computer readable signal containing said identifying address. For instance, the computing entity 200 may be required to send an identifying address along with login credentials to the access the display 316. In some preferred embodiments, login credentials and the identifying address may be saved by the system as log data 425C, wherein said log data 425C may allow the system 400 to keep a record on which users 405 access which computing entities and/or displays 316 of the system 400. Other types of data that may be saved by the system 400 as log data 425C includes, but is not limited to, login time, login date, geolocation data, image data 425B, or any combination thereof.

In another preferred embodiment, the system may comprise an airdrop system. In a preferred embodiment, the air drop system is secured to a covering that is configured to fit around a portable digital pod system placed in a collapsed position in order to create a payload. In one preferred embodiment, the air drop system comprises a parachute system having a canopy, riser line, and a plurality of suspension lines connecting said riser line to said canopy. The riser line is secured to the payload via the covering. When the payload and airdrop system are ejected from a moving airplane, the canopy for the airdrop system is configured to expand, resulting in air resistance that slow the fall speed of the payload. In some embodiments, multiple airdrop systems may be secured to the payload. In a preferred embodiment, the canopy is an air Ram Air Parachute. In another preferred embodiment, the airdrop system may further comprise an airborne guidance unit configured to manipulate the canopy during flight in order to guide the payload to a desired geolocation.

To prevent un-authorized user 405 from accessing other user's 405 information, the system 400 may employ a digital security method. As illustrated in FIG. 11, the digital security method of the system 400 may comprise a plurality of permission levels 1100 that may grant users 405 access to user content 1115, 1135, 1155 within the database 115 while simultaneously denying users 405 without appropriate permission levels 1100 the ability to view user content 1115, 1135, 1155. To access the user content 1115, 1135, 1155 stored within the database 115, users 405 may be required to make a request via a user interface 411. Access to the data within the database 115 may be granted or denied by the processor 220 based on verification of a requesting user's 1105, 1125, 1145 permission level 1100. If the requesting user's 1105, 1125, 1145 permission level 1100 is sufficient, the processor 220 may provide the requesting user 1105, 1125, 1145 access to user content 1115, 1135, 1155 stored within the database 115. Conversely, if the requesting user's 1105, 1125, 1145 permission level 1100 is insufficient, the processor 220 may deny the requesting user 1105, 1125, 1145 access to user content 1115, 1135, 1155 stored within the database 115. In an embodiment, permission levels 1100 may be based on user roles 1110, 1130, 1150 and administrator roles 1170, as illustrated in FIG. 11. User roles 1110, 1130, 1150 allow requesting users 1105, 1125, 1145 to access user content 1115, 1135, 1155 that a user 405 has uploaded and/or otherwise obtained through use of the system 400. Administrator roles 1170 allow administrators 1165 to access system 400 wide data.

In an embodiment, user roles 1110, 1130, 1150 may be assigned to a user in a way such that a requesting user 1105, 1125, 1145 may view user profiles 425 containing user data 425A, image data 425B, and log data 425C via a user interface 411. To access the data within the database 115, a user 405 may make a user request via the user interface 411 to the processor 220. In an embodiment, the processor 220 may grant or deny the request based on the permission level 1100 associated with the requesting user 1105, 1125, 1145. Only users 405 having appropriate user roles 1110, 1130, 1150 or administrator roles 1170 may access the data within the user profiles 425. For instance, as illustrated in FIG. 11, requesting user 1 1105 has permission to view user 1 content 1115 and user 2 content 1135 whereas requesting user 2 1125 only has permission to view user 2 content 1135. Alternatively, user content 1115, 1135, 1155 may be restricted in a way such that a user may only view a limited amount of user content 1115, 1135, 1155. For instance, requesting user3 1145 may be granted a permission level 1100 that only allows them to view user 3 content 1155 related to their specific financial institution but not user 3 content 1155 related to other financial institutions. In the example illustrated in FIG. 11, an administrator 1165 may bestow a new permission level 1100 on users so that it may grant them greater permissions or lesser permissions. For instance, an administrator 1165 may bestow a greater permission level 1100 on other users so that they may view user 3's content 1155 and/or any other user's 405 content 1115, 1135, 1155. Therefore, the permission levels 1100 of the system 400 may be assigned to users 405 in various ways without departing from the inventive subject matter described herein.

FIG. 12 provides a flow chart 1200 illustrating certain, preferred method steps that may be used to carry out the method of setting up a plurality of collapsible pods 410 in remote locations. Step 1205 indicates the beginning of the method. During step 1210, a user 405 may obtain a collapsible pod 410 that is in a closed position and subsequently obtain a hydraulic/pneumatic pack 415 during step 1215. In one preferred embodiment, the collapsible pod 410 and hydraulic/pneumatic pack 415 are two separate devices; however, in other embodiments, the collapsible pod 410 and hydraulic/pneumatic pack 415 are as one unit. Once the user 405 has obtained the collapsible pod 410 and the hydraulic/pneumatic pack 415, the user 405 may unlock the collapsible pod 410 in a way such that it may be placed in an extended position during step 1220. The user 405 may then secure the hydraulic/pneumatic pack 415 to a hydraulic/pneumatic arm 410C of the collapsible pod 410 during step 1225.

Once the hydraulic/pneumatic pack 415 is secured to the hydraulic/pneumatic arm 410C of the collapsible pod 410, the user 405 may turn on the hydraulic/pneumatic pack 415 and operate it in a way that causes the hydraulic/pneumatic arm 410C to move from a first position to a second position during step 1230. In a preferred embodiment, movement of the hydraulic/pneumatic arm 410C from the first position to the second position causes the collapsible pod 410 to move from a collapsed position to an extended position. The user 405 may lock the hydraulic/pneumatic arm 410C into the second position during step 1235, preventing the collapsible pod 410 from reverting back to the closed position. After locking the collapsible pod 410 into an extended position, the user 405 may turn off the hydraulic/pneumatic pack 415 during step 1240 and subsequently remove the hydraulic/pneumatic pack 415 during step 1245. The user 405 may then perform a query to determine if an additional collapsible pod 410 needs to be placed in an extended position during step 1250.

Based on the results of the query, the user 405 may take an action during step 1255. If the user 405 determines that said additional collapsible pod 410 needs to be placed in an extended position, the user 405 may obtain the additional collapsible pod 410 during step 1257 and subsequently return to step 1220, wherein the user 405 may setup the additional collapsible pod 410 in the same manner as they did the previous collapsible pod 410. If the user 405 determines that no additional collapsible pod 410 need to be placed in an extended position, the user 405 may proceed to step 1260, wherein the user 405 may connect the wireless communication interface to the system 400. In the preferred embodiment, the wireless communication interface allows the system 400 to communicate with a network via satellite, but other wireless communication interfaces may be used without departing from the inventive subject matter described herein. In some preferred embodiments, the wireless communication interface may be integrated into the system 400 and not require connection to the system 400, obviating the need for step 1260. For instance, a system 400 comprising a wireless communication interface integrated into the control board 412 of the display 316 that allows the system 400 to wirelessly connect to a network via a mobile communication standard within a cellular network, such as LTE, may be integrated in a way such that the system 400 automatically connects to said network when the control board 412 receives power from a power supply.

The user 405 may then connect a computing entity 200 to the display 316 of the collapsible pod 410 during step 1265. The computing entity 200 is configured to communicate with the display 316 of the system 400 in a way that allows the mobile computing device to transmit data of the system 400 to the display 316 so that it may be presented within the display user interface of the display 316. In a preferred embodiment, the display 316 of a collapsible pod 410 is located within the interior space created by the collapsible pod 410 when placed in an extended position. Once the computing entity 200 has been paired with the display 316, the user 405 may proceed to terminate method step 1270. In embodiments where additional collapsible pods 410 were placed in the extended position by the hydraulic/pneumatic pack 415, the user 405 may have to connect a wireless communication interface and/or one or more computing entities thereto. However, some embodiments of the system 400 may allow for a wireless communication interface and/or one or more computing entities to work for multiple collapsible pods 410. For instance, a single satellite network communication interface may be used by multiple collapsible pods 410 to access to a network, wherein a router of a host collapsible pod 410 allows for a plurality of additional collapsible pods 410 to connect to the network through the satellite network communication interface of the host collapsible pod 410.

The subject matter described herein may be embodied in systems, apparati, methods, and/or articles depending on the desired configuration. In particular, various implementations of the subject matter described herein may be realized in digital electronic circuitry, integrated circuitry, specially designed application specific integrated circuits (ASICs), computer hardware, firmware, software, and/or combinations thereof. These various implementations may include implementation in one or more computer programs that may be executable and/or interpretable on a programmable system including at least one programmable processor, which may be special or general purpose, coupled to receive data and instructions from, and to transmit data and instructions to, a storage system, and at least one peripheral device.

These computer programs, which may also be referred to as programs, software, applications, software applications, components, or code, may include machine instructions for a programmable processor, and may be implemented in a high-level procedural and/or object-oriented programming language, and/or in assembly machine language. As used herein, the term “non-transitory computer-readable medium” refers to any computer program, product, apparatus, and/or device, such as magnetic discs, optical disks, memory, and Programmable Logic Devices (PLDs), used to provide machine instructions and/or data to a programmable processor, including a non-transitory computer-readable medium that receives machine instructions as a computer-readable signal. The term “computer-readable signal” refers to any signal used to provide machine instructions and/or data to a programmable processor. To provide for interaction with a user, the subject matter described herein may be implemented on a computer having a display device, such as a cathode ray tube (CRD), liquid crystal display (LCD), light emitting display (LED) monitor for displaying information to the user and a keyboard and a pointing device, such as a mouse or a trackball, by which the user may provide input to the computer. Displays 316 may include, but are not limited to, visual, auditory, cutaneous, kinesthetic, olfactory, and gustatory displays, or any combination thereof.

Other kinds of devices may be used to facilitate interaction with a user as well. For instance, feedback provided to the user may be any form of sensory feedback, such as visual feedback, auditory feedback, or tactile feedback; and input from the user may be received in any form including, but not limited to, acoustic, speech, or tactile input. The subject matter described herein may be implemented in a computing system that includes a back-end component, such as a data server, or that includes a middleware component, such as an application server, or that includes a front-end component, such as a client computer having a graphical user interface or a Web browser through which a user may interact with the system described herein, or any combination of such back-end, middleware, or front-end components. The components of the system may be interconnected by any form or medium of digital data communication, such as a communication network. Examples of communication networks may include, but are not limited to, a local area network (“LAN”), a wide area network (“WAN”), metropolitan area networks (“MAN”), and the internet.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For instance, the implementations described above can be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, devices, and arrangements of the parts and method stages which have been described and illustrated in order to explain the nature of this inventive subject matter can be made without departing from the principles and scope of the inventive subject matter.

What is claimed is:

1) A system for a portable pod comprising,
a framework operably connected to a hydraulic/pneumatic arm,
wherein said hydraulic/pneumatic arm alters a position of said framework,
a projectile resistant exterior shell connected to said framework,
wherein said projectile resistant exterior shell forms an exterior structure that protects an internal cavity created by said framework when said hydraulic/pneumatic arm causes said framework to be placed into an extended position,
wherein an opening within said projectile resistant exterior shell allows for access to said internal cavity, and
a display located within said internal cavity that is created when said framework is placed in said extended position,
wherein said display is secured to at least one of said framework or an internal wall of said internal cavity,
a control board operably connected to said display,
a secondary security device operably connected to said control board,
wherein said secondary security device is configured to validate login credentials of a user before allowing a user to access said display.

2) The system of claim 1, further comprising a camouflaged jacket configured to secure to an exterior surface of the projectile resistant exterior shell.

3) The system of claim 2, wherein said camouflaged jacket is infused with para-aramid fibers in order to increase projectile resistance.

4) The system of claim 1, further comprising a hydraulic/pneumatic pack configured to cause said hydraulic/pneumatic arm to move said framework from a collapsed position to said extended position.

5) The system of claim 4, wherein said hydraulic/pneumatic pack is removably secured to said hydraulic/pneumatic arm.

6) The system of claim 4, wherein said control board is operably connected to said hydraulic/pneumatic pack.

7) The system of claim 6, further comprising a computing entity having a user interface and operably connected to said control board.

8) The system of claim 7, wherein said user interface of said computing entity allows a user to control said hydraulic/pneumatic pack in a way such that said user may cause said hydraulic/pneumatic pack to place said framework in said collapsed position and said extended position.

9) The system of claim 7, wherein said computing entity allows a user to transmit image data to said display, wherein said display may present said image data within a display user interface.

10) The system of claim 1, further comprising a wireless communication device secured to an exterior surface of said projectile resistant exterior shell.

11) The system of claim 10, further comprising a drone operably connected to said wireless communication device, wherein a computing device connected to a control board of said display may be used to control said drone.

12) A system for a portable pod comprising,
a first framework operably connected to a first hydraulic/pneumatic arm,
wherein said first hydraulic/pneumatic arm alters a position of said first framework,
a second framework operably connected to a second hydraulic/pneumatic arm,
wherein said second hydraulic/pneumatic arm alters said position of said second framework,
a first projectile resistant exterior shell connected to said first framework,
wherein an opening within said first projectile resistant exterior shell allows for access to an internal cavity created when said first framework is placed in and extended position,
a second projectile resistant exterior shell connected to said second framework,
wherein said opening within said second projectile resistant exterior shell allows for access to said internal cavity created when said second framework is placed in and extended position,
wherein said first projectile resistant exterior shell and said second projectile resistant exterior shell are configured to secure to one another when said first projectile resistant exterior shell and said second projectile resistant exterior shell are placed in an extended position,
a display located within said internal cavity that is created when said first framework and second framework are placed in said extended position,
wherein said display is secured to at least one of said first framework, second framework, or an internal wall of said internal cavity,
a control board operably connected to said display,
a secondary security device operably connected to said control board,
wherein said secondary security device is configured to validate login credentials of a user before allowing a user to access said display.

13) The system of claim 12, further comprising a camouflaged jacket configured to secure to an exterior surface of at least one of said first projectile resistant exterior shell and said second projectile resistant exterior shell.

14) The system of claim 13, wherein said camouflaged jacket is infused with para-aramid fibers in order to increase projectile resistance.

15) The system of claim 13, further comprising a hydraulic/pneumatic pack that is removably secured to at least one of said first hydraulic/pneumatic arm and said second hydraulic/pneumatic arm,
wherein said hydraulic/pneumatic pack is configured to cause at least one of said first hydraulic/pneumatic arm or said second hydraulic/pneumatic arm to move said frameworks from a collapsed position to said extended position.

16) The system of claim 15, further comprising a computing entity having a user interface and operably connected to said control board and said hydraulic/pneumatic pack.

17) The system of claim 16, wherein said computing entity allows a user to transmit image data to said display, wherein said display may present said image data within a display user interface.

18) The system of claim 13, further comprising a wireless communication device secured to the exterior surface of at least one of said first projectile resistant exterior shell or said second projectile resistant exterior shell.

19) The system of claim 18, further comprising a drone operably connected to said wireless communication device, wherein a computing device connected to a control board of said display may be used to control said drone.

20) A method for deploying a portable pod system comprising,
obtaining a payload comprising at least one portable digital pod, hydraulic/pneumatic pack, and camouflaged jacket encapsulated within a covering,
obtaining an airdrop system configured to secure to said payload,
securing said airdrop system to said covering of said payload,
loading said payload and said airdrop system onto a cargo plane,
dropping said payload and said airdrop system out of said cargo plane when approaching a desired geolocation,
retrieving said payload once said payload has reached ground level,
removing said at least one portable digital pod, hydraulic/pneumatic pack, and camouflaged jacket from said covering,
securing said hydraulic/pneumatic pack to a hydraulic/pneumatic arm of said at least one portable digital pod,
manipulating said hydraulic/pneumatic pack in a way such that said hydraulic/pneumatic arm causes a framework of said at least one portable digital pod to move from a collapsed position to a extended position,
locking said framework into said extended position, and
attaching said camouflaged jacket to an exterior shell of said at least one portable digital pod.
